(19) United States
(12) Patent Application Publication
(10) Pub. No.: US 2026/0163491 A1
(43) Pub. Date: Jun. 11, 2026

(54) METHOD FOR CONTROLLING A VOLTAGE CONVERTER

(71) Applicant: Wise-Integration, Hyeres (FR)

(72) Inventors: Dominique Bergogne, Saint-Didier-En-Velay (FR); Alain Bailly, Rousset (FR)

(73) Assignee: Wise-Integration, Hyeres (FR)

(21) Appl. No.: 18/709,335

(22) PCT Filed: Nov. 17, 2022
(86) PCT No.: PCT/EP2022/082184

§ 371 Date: May 10, 2024

(30) Foreign Application Priority Data
Nov. 22, 2021 (FR) FR2112341

(51) Int. Cl. H02M 3/335; H02M 1/00

(52) U.S. Cl. CPC H02M 3/33584; H02M 1/0058; H02M 3/33571; H02M 3/33573

(57) ABSTRACT

The invention relates to a method for controlling a voltage converter consisting of switching the switches of the inverter arms of the primary and secondary circuits to deliver an output voltage (Vout), characterised in that when the power absorbed between the input terminals of the primary circuit is comprised between two predetermined thresholds, the switches of the primary circuit are controlled to make twice as many switchings as the switches of the secondary circuit over a given period.

### TECHNICAL FIELD

The invention relates to the field of electrical power converters, making it possible to deliver a direct voltage.

The invention relates more specifically to a voltage converter, making it possible to limit energy losses during the switching of switches, in particular for powers less than a predetermined threshold.

### STATE OF THE ART

Conventionally, DC voltage converters make it possible to convert a direct electrical energy, having a given voltage level, into a direct energy having another voltage level, whether it is greater or lower.

There are many applications. DC conversion within on-board avionic or railway networks can, for example, be cited, or also battery chargers of electronic devices or electric vehicles.

The invention relates more specifically to “Dual Active Bridge” (DAB) converters. These converters have a particular electronic structure based on a central inductive element, such as a transformer. A first winding of the transformer is connected to a primary circuit comprising two terminals intended to be directly or indirectly connected to an alternating or direct voltage source. The primary circuit further comprises an inverter arm comprising two switches, thus forming a so-called “half-bridge” or “full-bridge” structure, when two inverter arms are present. The second winding of the inductive element is connected to a secondary circuit supplying a direct output voltage. The secondary circuit also comprises an inverter arm comprising two switches, thus forming a half-bridge or full-bridge structure, when two inverter arms are present.

An example of a DAB-type converter powered by an alternating voltage source is illustrated in document FR3099663.

By making the switches of the primary and secondary circuits switch at predetermined frequencies, which can moreover vary over time, it is possible to modulate the output voltage of the converter.

However, outside of certain predetermined ranges of power, the components of the converter excessively heat up, which can lead to the decrease in performance of the converter, even to the decrease in its service life.

Thus, it is sought to limit this heating up, by making the switches of the inverter arms of the converter switch when the voltage at their terminals is zero. The switching into “Zero Voltage Switching” (ZVS) can be obtained by using the current present in the inductive element of the converter to discharge the interference capacities present at the terminals of the switches of the inverter arms. When the interference capacity is discharged, the voltage is thus equal to zero and the conduction of the switch can be caused with minimum energy dissipated in the form of heat. However, this solution generally requires knowing the value of the instantaneous current. Yet, the instantaneous detection of a magnitude, and its immediate consideration for an almost-immediate action is very complex to implement within a voltage converter.

Furthermore, the current operation of DAB-type converters does not make it possible to maintain the conditions of switching into ZVS over the whole range of power transmitted. Indeed, when the power transmitted decreases and passes below a predetermined threshold, the current passing through the central inductive element is too low to make it possible to perform switching into ZVS.

The technical problem that is proposed to resolve the invention is to develop a method for controlling a voltage converter, making it possible to limit energy losses during the switching of switches, in particular for powers less than a predetermined threshold.

### SUMMARY OF THE INVENTION

To resolve this problem, the Applicant has developed a method for controlling two main categories of voltage converters. A first category relates to converters directly powered by a direct voltage source, such as a battery. The second category relates to converters powered by an alternating voltage source.

Thus, according to a first aspect, the invention relates to a method for controlling a voltage converter comprising:
a primary circuit comprising:
   two main terminals intended to be connected to a source delivering a direct input voltage,
   at least one first inverter arm comprising two switches, the first inverter arm being connected to said input terminals,
   a first capacitive arm comprising at least two capacitive elements, the first capacitive arm being mounted in parallel with the first inverter arm, and
   a first winding of a transformer, connected between a first interconnecting point located between the switches of the first inverter arm and a second interconnecting point located between capacitive elements of the first capacitive arm, and
a secondary circuit comprising:
   at least one second inverter arm comprising two switches,
   a second capacitive arm comprising at least two capacitive elements, the second capacitive arm being mounted in parallel with the second inverter arm, and
   a second winding of said transformer, connected between a third interconnecting point located between the switches of the second inverter arm and a fourth interconnecting point located between capacitive elements of the second capacitive arm. The method implements the switching of switches of the inverter arms of the primary and secondary circuits to deliver an output voltage.

The method is characterised in that when the power absorbed between the input terminals by the direct voltage source of the primary circuit is comprised between two predetermined thresholds, the switches of the primary circuit are controlled to make twice as many switchings as the switches of the secondary circuit over a given period.

In other words, if the voltage supplied by the direct voltage source is called A, and the voltage present on the second capacitive arm is called B, the switching of the switches of the inverter arms of the primary and secondary circuits thus makes it possible to control the energy exchanges between the voltage source A and the voltage source B.

According to a second aspect, the invention also relates to a method for controlling a voltage converter comprising:
a primary circuit comprising:
   two main terminals intended to be connected to an alternating voltage source,
   a rectifier stage delivering a direct voltage, one of the input terminals of the rectifier stage being connected to one of the main input terminals,
   at least one first inverter arm comprising two switches, the first inverter arm being connected between the output terminals of the rectifier stage,
   a first capacitive arm comprising at least two capacitive elements, the first capacitive arm also being connected between the output terminals of the rectifier stage, and
a first winding of a transformer, connected between a first interconnecting point located between the switches of the first inverter arm and a second interconnecting point connected to the other main terminal, said second interconnecting point being located between capacitive elements of the first capacitive arm, and
a secondary circuit comprising:
   at least one second inverter arm comprising two switches,
   a second capacitive arm comprising at least two capacitive elements, the second capacitive arm being mounted in parallel with the second inverter arm, and
   a second winding of said transformer, connected between a third interconnecting point located between the switches of the second inverter arm and a second interconnecting point located between the capacitive elements of the second capacitive arm.

The method implements the switching of the switches of the inverter arms of the primary and secondary circuits to deliver an output voltage.

It is characterised in that, when the power absorbed between the input terminals of the primary circuit is comprised between two predetermined thresholds, the switches of the primary circuit are controlled to make twice as many switchings as the switches of the secondary circuit over a given period.

Thus, by making twice as many switchings of the switches of the primary circuit, the current in the inductive element is maintained at a level sufficient to make it possible to maintain the switching into ZVS in the primary circuit, for powers transmitted between the two predetermined thresholds. The determination of the time necessary for switching into ZVS is, for example, obtained by the real-time digital resolution of an equation system, or also by way of a look-up table.

Thanks to the switching into ZVS, the components of the converter almost do not heat up, which makes it possible to extend the service life of the converter and to increase its energy efficiency.

According to the invention, the given period corresponds to a specific time interval, which is not necessarily reproduced identically over time. In particular, the duration of the period can be variable over time, according to the power delivered by the converter. As an example, the period has a duration of around a few microseconds.

In practice, the second winding of said transformer is connected to the first interconnecting point by way of an inductive element, which can be constituted of the leakage inductance of the transformer, or include the leakage inductive and in series with another inductive element. Likewise, the rectifier stage delivering a direct voltage comprises, in practice, an inverter arm comprising two switches and one output condenser, mounted in parallel with the inverter arm.

In an advantageous embodiment, it is also sought to make the switches switch, when the current which passes through them is zero, in order to limit energy losses by Joule effect. Zero current switching (ZCS) is applied to the switches of the secondary circuit. Thus, over the given period, the switchings of the switches of the secondary circuit are performed at each passage through a zero value of the current in the inductance of the second winding, and for a variation direction of the given current.

Thus, zero passage switchings of the current are not systematically generated. The current can therefore change sign without changing the polarity of the output voltage. A certain quantity of energy can thus return to the primary circuit. Doing this, the range of power transmitted, for which the switchings into ZVS and ZCS are maintained, has a lower terminal lowered compared with the control methods of the prior art. Thus, the operating range for which the losses are reduced is extended.

In practice, over the given period, after the switching of the switches of the primary circuit, an additional switching of the switches of the primary circuit is generated, after the current in the second winding of the transformer has changed direction, so as to cause a new zero passage of said current, synchronously to said new zero passage, a switching of the switches of the second circuit is generated.

According to the invention, the switches of the inverter arms of the primary circuit switch in pairs. This means that when the voltage in the primary circuit passes from a high state to a low state or from a low state to a high state, the switches of the inverter arm switch substantially simultaneously such that a first switch passes from a closed state to an open state and that the second switch passes from an open state to a closed state, without ever being conductors at the same time. This operation is also applied to the switches of the secondary circuit.

Concerning the electronic structure of the converter powered by a direct voltage source, the primary circuit can comprise two inverter arms so as to form a so-called full-bridge structure.

In principle, the switches are unidirectional switches. However, in certain applications, the switches of the primary circuit can be bidirectional switches thus making it possible to apply an alternating voltage instead of the direct voltage. The latter are generally formed of two switches in series, and can enable the control of the passage from a current in both directions. For example, the bidirectional switches can be formed of two transistors in series and connected by their source.

### DESCRIPTION OF THE FIGURES

The way to implement the invention, as well as the advantages which result from it, will emerge from the description of the following embodiments, in support of the accompanying figures, in which:

FIG. 1 is an electric diagram of a voltage converter according to a first embodiment of the invention,

FIG. 2 is an electric diagram of a voltage converter according to a second embodiment of the invention,

FIG. 3 is a diagram illustrating the development of the voltage in the primary and secondary circuits and of the current in the inductance during a given period for the voltage converter of FIG. 1, and

FIG. 4 is an equation system making it possible to determine the switching instants of the switches of the converter of FIG. 1.

### DETAILED DESCRIPTION OF THE EMBODIMENTS

Below in this description, an ideal transformer with a ratio equal to 1 is considered. In other words, the ratio m=Ns/Np between the number of coils Ns of the second winding E2, E12, and the number of coils Np of the first winding E1, E11 is equal to 1. This event makes it possible to simplify the following examples, but the invention also applies for any value m. Thus, with m=1, the current Is passing through the secondary circuit of the transformer and the current Ip passing through the primary circuit of the transformer are such that Is=Ip.

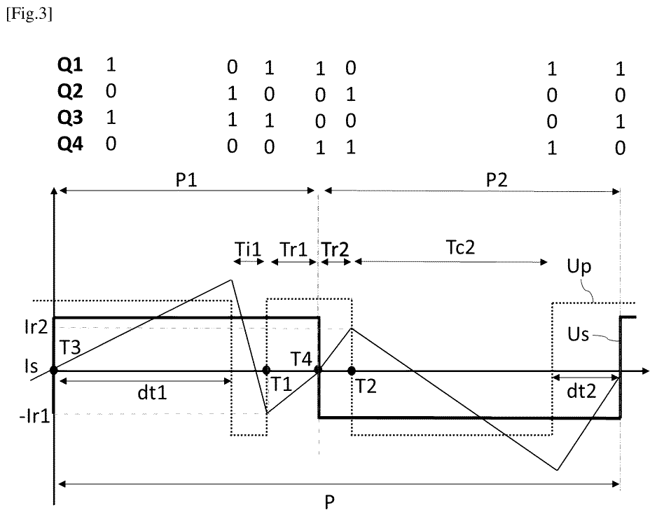

Furthermore, to simplify the representation of the state of a switch Q1-Q4, Q11-Q14, in particular in FIG. 3, an open state is referenced “0” and a closed state is referenced “1”.

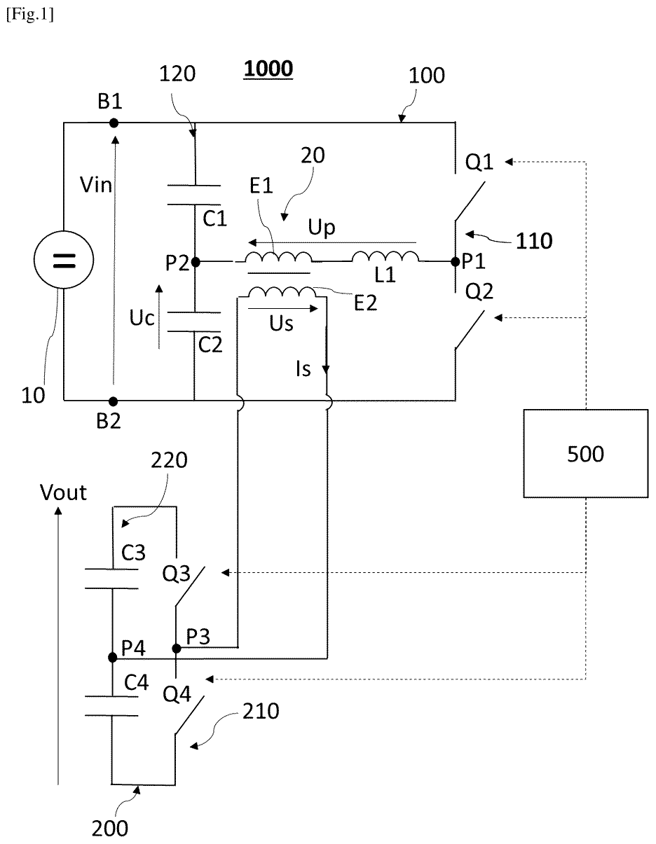

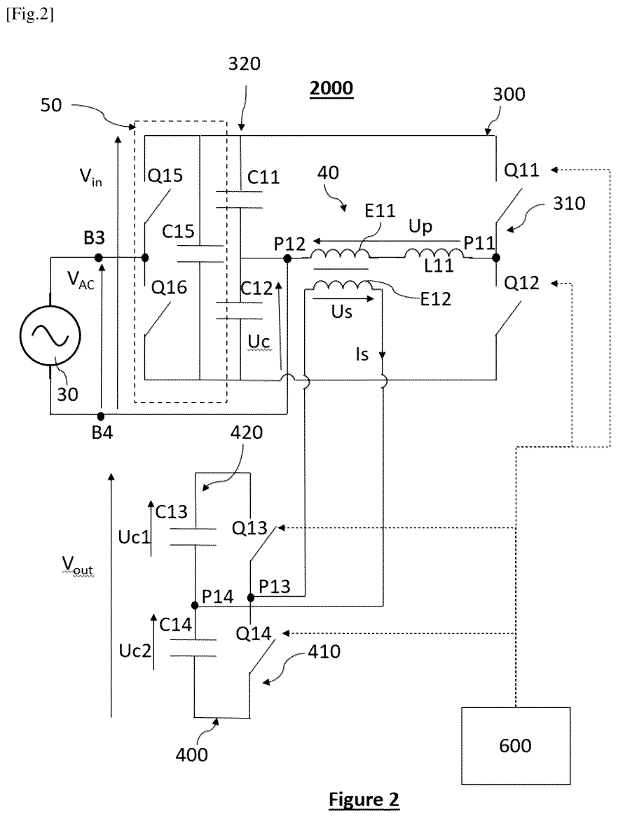

Such as illustrated in FIGS. 1 and 2, a voltage converter 1000, 2000 comprises a transformer 20, 40 mounted in series with an inductance L1, L11, which can be constituted of the leakage inductance of the transformer, or include the latter in series with a specific inductive element. The transformer 20, 40 comprises a first winding E1, E11, connected to the primary circuit 100, 300 and a second winding E2, E12, connected to the secondary circuit 200, 400.

Within the primary circuit 100, 300, a first terminal P1, P11 of the first winding E1, E11 is connected between two switches Q1, Q2, Q11, Q12 of an inverter arm 110, 310 by way of the inductance L1, L11, or directly if this inductance is comprised in the transformer 20, 40.

Such as illustrated in FIG. 1, in a first embodiment, the second terminal P2 of the first winding El is connected between two condensers C1, C2 of a capacitive arm 120. The input voltage Vin is measured between the main terminals B1 and B2, connected to the terminals of the capacitive arm 120. The main terminals B1, B2 are powered by a direct voltage source 10.

Such as illustrated in FIG. 2, in a second embodiment, the second terminal P12 of the first winding E11 is connected to a main terminal B4, powered by an alternating voltage source 30, typically coming from the electrical network. The latter is also connected to a second main terminal B3, itself connected to a rectifier stage 50. The input voltage Vin is measured between the main terminals B3 and B4.

In a variant, the inductance L1, L11 and the transformer 20, 40 can be swapped, i.e. that the second terminal P2 of the first winding El can be connected, by way of the inductance L1, between the two condensers C1, C2 of a capacitive arm 120 and the second terminal P12 of the first winding E11 can be connected, by way of the inductance L11, to the main terminal B4.

The rectifier stage 50 comprises an inverter arm equipped with two switches Q15, Q16 between which the main terminal B3 is connected. The rectifier stage 50 further comprises a capacitive arm comprising a condenser C15, connected to the terminals of the inverter arm. The output terminals of the rectifier stage 50 are connected to the terminals of the inverter arm 310. Furthermore, the inverter arm 310 is itself connected to a capacitive arm 320 comprising at least two condensers C11, C12.

In the two FIGS. 1 and 2, within the secondary circuit 200, 400, a first terminal P3, P13 of the second winding E2, E12 is connected to the two switches Q3, Q4, Q13, Q14 of an inverter arm 210, 410. The second terminal P4, P14 of the second winding E2, E12 is connected between two condensers C3, C4, C13, C14 of a capacitive arm 220, 420. The output voltage Vout is obtained at the terminals of the capacitive arm 220, 420.

The switches Q1-Q4, Q11-Q14 are controlled by a control circuit 500, 600 configured to implement the control method of the invention. To do this, the control circuit 500, 600 opens and/or closes the switches Q1-Q4, Q11-Q14 of the inverter arms 110, 210 of the primary 100 and secondary 200 circuits to deliver the requested output voltage Vout, whatever the power level.

In practice, the method of the invention is applied when the power absorbed between the input terminals B1-B4 is comprised between two predetermined power thresholds.

The switches Q1, Q2, Q11, Q12 of the primary circuit 100, 300 are thus controlled to make twice as many switchings as the switches Q3, Q4, Q13, Q14 of the secondary circuit 200, 400, over a given period P.

The predetermined power thresholds between which the invention applies are dependent on the parameters of the converter. As an example, the thresholds can depend on the size or the age of the components constituting the converter, or also on the requested power and voltages and currents involved at the output of the converter.

The upper threshold is determined according to the interest in making twice as many switchings for the switches of the primary circuit. Indeed, from this threshold, the value of the current is generally sufficient to systematically cause the operation into ZVS. The principle of the additional switchings provided by the invention is no longer able to provoke interest.

The lower threshold is determined according to the energy loss ratio caused by the switchings. Indeed, for powers less than this threshold, making twice as many switches for the switches of the primary circuit causes more energy losses than conventional switching methods, such as hard or pulse by pulse switching. Below this threshold, switches by one of these conventional methods must therefore be controlled.

In practice, the diagram of FIG. 3 illustrates the development of the voltage Up at the terminals of the assembly formed by the inductance L1 and the first winding E1, and of the voltage Us at the terminals of the second winding E2, as well as the current Is in the second winding E2 of the transformer 20, over a given period P in a circuit corresponding to FIG. 1. The description below can also apply to the circuit of FIG. 2.

Over a first phase of a duration dt1, the switches Q1 of the primary circuit and Q3 of the secondary circuit are closed while the switches Q2 of the primary circuit and Q4 of the secondary circuit are open.

As a first approximation, the voltage Up and the voltage Us are signals which could adopt two values: a high state and a low state. Over the first phase dt1, the voltage Up and the voltage Us are in a high state. The current Is is increasing and its gradient proportional to the value of the inductance and to the voltage difference between Up and Us.

Over a second phase of a duration Ti1, the switches Q2 of the primary circuit and Q3 of the secondary circuit are closed while the switches Q1 of the primary circuit and Q4 of the secondary circuit are open. In other words, the switch Q1 passes from the closed state to the open state while the switch Q2 is closed.

The voltage Up therefore passes from the high state to the low state and the voltage Us remains unchanged. The current Is is thus decreasing, its gradient always being proportional to the voltage difference between Up and Us. The variation of the current Is has therefore changed direction with respect to the preceding sequence phase.

Over a third phase Tr1, the switches Q1 of the primary circuit and Q3 of the secondary circuit are closed while the switches Q2 of the primary circuit and Q4 of the secondary circuit are open. In other words, the switch Q1 is closed while the switch Q2 is open again. The output voltage Vout does not change, as the switches Q3, Q4 of the secondary circuit have not changed state.

The voltage Up therefore passes again to the high state and the voltage Us always remains unchanged. The current Is is thus again increasing and its gradient is identical to the gradient of the phase dt1. This makes it possible for the current to again pass through a zero value at the instant T4, which corresponds to the ZCS condition, and to trigger the fourth phase to switch the switches Q3 and Q4 with minimal switching losses.

Over this fourth phase Tr2, the switches Q1 of the primary circuit and Q4 of the secondary circuit are closed while the switches Q2 of the primary circuit and Q3 of the secondary circuit are open.

The voltage Up therefore remains unchanged while the voltage Us passes from the high state to the low state. The current Is remains increasing, but with a gradient proportional to the voltage difference between Up and Us, i.e. greater than for the phases dt1 and Tr1.

Over a fifth phase Tc2, the switches Q2 of the primary circuit and Q4 of the secondary circuit are closed while the switches Q1 of the primary circuit and Q3 of the secondary circuit are open.

The voltage Up passes from the high state to the low state, while the voltage Us remains in the low state. The current Is in the second winding E12 of the transformer is thus decreasing and passes from a positive value to a negative value.

Over a sixth phase dt2, the switches Q1 of the primary circuit and Q4 of the secondary circuit are closed while the switches Q2 of the primary circuit and Q3 of the secondary circuit are open.

The voltage Up passes from the low state to the high state, while the voltage Us remains in the low state. The current Is in the second winding E2 of the transformer is thus increasing with a gradient equal to that of the phase Tr2.

The following phase, corresponding to the seventh phase, is identical to the first phase, and the period P has just been fully described. The switches Q1 of the primary circuit and Q3 of the secondary circuit are therefore again closed while the switches Q2 of the primary circuit and Q4 of the secondary circuit are again open. The voltage Up and the voltage Us are both in the high state and the current Is is again increasing with a gradient equal to that of the phases dt1 and Tr1. This is the start of a new period P.

In order to determine the switching instants of the switches Q1-Q4, a system comprising 8 equations and 8 unknown can be established and resolved digitally in real time. In a variant, a look-up table can be used. The equations of the system are obtained by the implementation of several conditions linking the electrical parameters of the diagram and their development over time.

The first condition relates to the switching into ZVS of the switches Q1-Q2. As a reminder, these switchings enabling the voltage at the terminals of a switch to become zero, and therefore to be able to close the latter by limiting energy losses. These switchings cause the state change of the voltage Up. The invention thus makes it possible to add two additional switchings, and these two switchings also being done in ZVS.

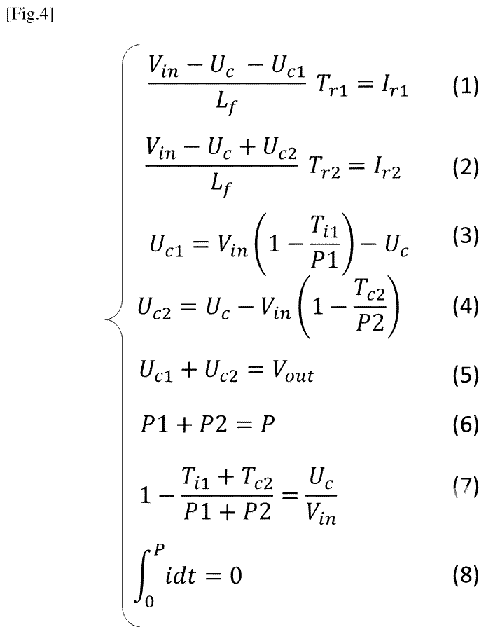

In FIG. 3, these switchings correspond to the points T1 and T2 of the phases Tr1 and Tr2. For these two points, the current Is is respectively-Ir1 and Ir2. Thus, the equations (1) and (2) illustrated in FIG. 4 are obtained.

The second condition relates to the switching into ZCS of the switches Q3-Q4. For the record, these switchings occur at instants chosen where the current Is passes through zero. In FIG. 3, these switchings correspond to the points T3 and T4. In order to establish the equations, it is known that the total increase of the current must be equal to its decrease over a period P. Thus, the increase of the current occurs while the voltage Us is positive, i.e. for the duration P1-Ti1 over the period P1 and for the duration P2 -Tc2 over the period P2. Thus, the equations (3) and (4) illustrated in FIG. 4 are obtained.

The third condition relates to the output voltage Vout, measured at the terminals of the capacitive arm 220. Thus, the output voltage Vout is the sum of the voltages of the condensers C3, C4 of the capacitive arm, that is Uc1+Uc2 in FIG. 3. Thus, the equation (5) illustrated in FIG. 4 is obtained.

The fourth condition relates to the period P described in FIG. 3. The period P is equal to the sum of the period P1 where the voltage Us is in the high state and of the period P2 where the voltage Us is in the low state. Thus, the equation (6) illustrated in FIG. 4 is obtained.

The fifth condition reflects the fact that the average voltage is zero at the terminals of the first winding E1 of the transformer 20. Thus, the voltage at the terminals of the condensers C1 and C2 is fixed. The equation (7) illustrated in FIG. 4 makes it possible to link the durations Tᵢ₁, T_{c2}, P₁ and P₂ according to the desired ratio between the voltage at the terminals of the inverter arm 310 of the primary circuit and the input voltage Vin. In the case of a continuous input voltage source, corresponding to FIG. 1, the ratio Uc/Vin is equal to ½. In the case of an alternating voltage source, corresponding to FIG. 2, the ratio Uc/Vin can vary and is chosen by the designer of the converter according to the breakdown voltage of the components.

The sixth condition relates to the obtaining of a stable voltage at the middle point of the two condensers C3 and C4 of the secondary circuit 200. If this voltage is not stabilised, when the current has a direct component, the voltage of the middle point between the condensers C3 and C4 can extend infinitely, which risks damaging the converter. In an established system, C3 and C4 are in series and powered in turn. In order to stabilise the middle point, the voltage must be distributed equally between the condensers C3 and C4. The total charge of C3 must therefore be equal to the total charge of C4 over the period P. In other words, the difference of the areas under the curve of the current, for the durations P1 and P2 must be zero. Thus, the equation (8) illustrated in FIG. 4 is obtained.

In practice, the control circuit 500 is configured to measure the input voltage Vin, the output voltage Vout, the voltage Uc at the terminals of the condenser C2 and the current Is in the second winding E2 of the transformer 20. The unknown variables of the system are therefore the variables: Uc1, Uc2, Tr1, Tr2, P1, Ti1, P2, Tc2.

Any digital method for resolving equations can make it possible to digitally determine the value of the variables. In particular, the resolution can be done in real time. Advantageously, the resolution is done in a few microseconds.

Furthermore, the operating frequency of the converter is not fixed, it therefore does not occur in calculations. The switching instants are calculated directly from equations, such that it is possible to impose ZVS switchings on the switches of the primary circuit and ZCS switchings on the switches of the secondary circuit in order to limit energy losses during the switching of the switches, in particular for powers comprised between two predetermined thresholds.

There is also an alternative method for determining the switching instants of the switches Q1 and Q4, which comprises an estimation of certain values, for example the value of the peak current, associated with calculations at one single unknown, it all completed by regulation loops acting on the frequency(ies) and the duty ratio(s). The switching instants are thus determined directly from frequencies and duty ratios.

Moreover, due to the symmetry of the stages directly linked to the primary and to the secondary stage of the transformer, namely the stage formed by the components Q1, Q2, C1 and C2 on the one hand, and the stage formed by the components Q3, Q4, C3 and C4 on the other hand, it is also possible to obtain the benefit of the invention by doubling the switching frequency, not of the primary switches as described above, but of the secondary switches. The principle of the control method described above can be adapted, in particular by swapping the terms “primary” and “secondary”, to make the switches Q3, Q4 of the secondary circuit switch twice as many as the switches Q1, Q2 of the primary circuit over a given period P.

1. Method for controlling a voltage converter comprising:
a primary circuit comprising:
two main terminals intended to be connected to a source delivering a direct input voltage (Vin),
at least one first inverter arm comprising two switches, the first inverter arm being connected to said input terminals,
a first capacitive arm comprising at least two capacitive elements, the first capacitive arm being mounted in parallel with the first inverter arm, and
a first winding of a transformer, connected between a first interconnecting point located between the switches of the first inverter arm and a second interconnecting point located between capacitive elements of the first capacitive arm, and
a secondary circuit comprising:
at least one second inverter arm comprising two switches,
a second capacitive arm comprising at least two capacitive elements, the second capacitive arm being mounted in parallel with the second inverter arm, and
a second winding of said transformer, connected between a third interconnecting point located between the switches of the second inverter arm and a fourth interconnecting point located between capacitive elements of the second capacitive arm,
the method implementing the switching of the switches of the inverter arms of the primary and secondary circuits to deliver an output voltage (Vout), characterised in that when the power absorbed between the main terminals by the direct voltage source of the primary circuit is comprised between two predetermined thresholds, the switches of the primary circuit are controlled to make twice as many switchings as the switches of the secondary circuit over a given period.

2. Method for controlling a voltage converter comprising:
a primary circuit comprising:
two main terminals intended to be connected to an alternating voltage source,
a rectifier stage delivering a direct voltage, one of the input terminals or the rectifier stage being connected to one of the main input terminals,
at least one first inverter arm comprising two switches, the first inverter arm being connected between the output terminals of the rectifier stage,
a first capacitive arm comprising at least two capacitive elements, the first capacitive arm also being connected between the output terminals of the rectifier stage, and
a first winding of a transformer, connected between a first interconnecting point located between the switches of the first inverter arm and a second interconnecting point connected to the other main terminal, said second interconnecting point being located between capacitive elements of the first capacitive arm, and
a secondary circuit comprising:
at least one second inverter arm comprising two switches,
a second capacitive arm comprising at least two capacitive elements, the second capacitive arm being mounted in parallel with the second inverter arm, and
a second winding of said transformer, connected between a third interconnecting point located between the switches of the second inverter arm and a second interconnecting point located between the capacitive elements of the second capacitive arm,
the method implementing the switching of the switches of the inverter arms of the primary and secondary circuits to deliver an output voltage (Vout), characterised in that when the power absorbed between the main terminals of the primary circuit is comprised between two predetermined thresholds, the switches of the primary circuit are controlled to make twice as many switchings as the switches of the secondary circuit over a given period.

3. Method according to claim 1 wherein the first winding of said transformer is connected to the first interconnecting point by way of an inductive element.

4. Method according to claim 2, wherein the rectifier stage includes a condenser at the output.

5. Method according to claim 1 wherein the duration of the period is variable over time.

6. Method according to claim 1, wherein the primary circuit comprises two inverter arms.

7. Method according to claim 1 wherein the switches are unidirectional switches.

8. Method according to claim 1 wherein the switches of the primary circuit are bidirectional switches.

9. Method according to claim 1 wherein over the given period, the switchings of the switches of the secondary circuit are performed at each passage through a zero value of the current in the inductance of the second winding, and for a variation direction of the given current.

10. Method according to claim 1 wherein over the given period, after the switching of the switches of the primary circuit, an additional switching of the switches of the primary circuit is generated after the current in the second winding of the transformer has changed direction, so as to cause a new passage through zero of said current, synchronically to said new passage through zero, a switching of the switches of the secondary circuit is generated.
